(19) United States
(12) Patent Application Publication
(10) Pub. No.: US 2025/0265167 A1
(43) Pub. Date: Aug. 21, 2025

(54) Machine Advisor

(71) Applicants: Robert Sebastian Escorcio, Castro Valley, CA (US); Landon Tolentino Escorcio, Castro Valley, CA (US); Nicholas Liesenfeld, Castro Valley, CA (US)

(72) Inventors: Robert Sebastian Escorcio, Castro Valley, CA (US); Landon Tolentino Escorcio, Castro Valley, CA (US); Nicholas Liesenfeld, Castro Valley, CA (US)

(21) Appl. No.: 18/444,681

(22) Filed: Feb. 17, 2024

(51) Int. Cl. G06F 11/34

(52) U.S. Cl. CPC G06F 11/3438; G06F 11/3457

(57) ABSTRACT

Machine Advisor is a method, algorithm, and network for predicting user needs by detecting a user's activity on a local computer and providing advice before the user is fully aware of their needs. This is achieved without private information ever transiting outside of the user's machine. The advice is constructed on an ‘Insight Creator’ computer that has applications normally utilized by the target user. This computer observes Inter-Process Communications (IPC) between applications, the text transcribed by a local electronic assistant, and keyboard and other sources to determine what the user is trying to accomplish.

### CROSS-REFERENCE TO RELATED APPLICATIONS

63/525,969 Provisional patent.

### PRIOR ART

U.S. Pat. Nos. 11,368,443 B2, 10,718,031 B1, 10,185,917 B2, 9,832,159 B1, 9,521,252 B2, 8,638,908 B2, 7,676,034 B1, 6,519,571 B1

### BACKGROUND OF THE INVENTION

The invention is in the field of computing. It provides social connection and mentoring. Prior work in this area includes targeted advertising based on application content or web searches. With existing solutions users must provide private information to allow a machine to be aware of a user's needs. Systems that provide this advice are limited by being closely integrated with a content storage system specific to the advising system. This forces advising systems into either violating a user's privacy or providing very simplistic advertising based on keyword detection in content. Users distrust that these systems are handling their data in a private manner. Inevitably, the kinds of advice available is limited to what a particular content storage system knows about the user. This concern over privacy limits users' willingness to share the information necessary to receive high quality coaching, advice, and social connection. These limitations dilute the quality of the advice received because the systems have a more narrow view of the user's daily interactions than is ultimately needed for prediction of coaching needs.

The limitations of these solutions prevent providing expertise when the user needs the coaching the most. Current solutions in this area are only able to provide a very limited view of the user's actions but fail to detect the broader goal the user is either conscious or not conscious of having. Someone in this situation is not necessarily even aware of the right question to ask and so a single application view is very limiting. Solutions that require the user to have this awareness—such as one expecting someone that suffers from depression being aware of how to diagnose it—are unable to “see” the complete picture.

### SUMMARY OF THE INVENTION

The invention establishes a protocol for users to share personal information for use by systems seeking to use this information. Like the perfect mentor, the invention has the ability to uncover unconscious needs. It provides the framework to allow identification of user activity privately and presents the user with this discovery to allow the user to elect whether to share more information with interested parties.

The system provides a proactive advisory role by predicting needs. Any private information that can be determined from the interaction of Applications or queries, can be used to determine the user's needs or interests, which can then be used to predict the user's state and suggest means by which the user might proactively improve that state. It is a departure from prior work by enabling this evaluation of user needs to occur without private information ever leaving the user's computer

For example, the system can detect that the user is researching investments and their current wealth and experience based on their social media queries, web searches, or texting and can suggest strategies or web sites to explore. The user does not lose any privacy because no information about the user must leave the user's computer. Only a rating about the usefulness of Insight ever leaves the computer. An auction of prospective insights occurs automatically only within the confines of the user's computer.

### BRIEF DESCRIPTION OF DRAWINGS

The User Computer (FIG. 1) contains an application, Seeker, which receives Insight data objects from an InsightServer. Insight data objects contain an identifier of the contents of message text and a locale. The content displayed to the user utilizes the locale to look up the corresponding content provided by the Insight Creator.

The Seeker matches Insights to thoughts determined by a Neural Network evaluation of a Machine Learning model. The Seeker provides all inputs to the Neural Network evaluation. Inputs are provided from Inter-Process Communications (IPCs) between apps, recognized text from the application that provides a voice assistant to the user.

When Seeker detects a match it conducts an Auction (see FIG. 3: Insight Auction below) and the winning Insight is used to generate a notification with an action and an analogous screen for display in an Embedded UI. The Embedded UI can be placed by a developer within any application or web site to provide suggestions. If the action is selected by the user this triggers either a Seeker action or an application action.

A sentence represents a complete thought in simplified form: <noun> <verb> <direct object> <indirect object>. The Neural Network model is trained to output a thought from all its input sources. The thought is matched to an insight. An insight is one or more matching thoughts. Insights are created by the Insight Creator which is described in FIG. 2.

FIG. 2 depicts the Seeker operating in a special mode. In this mode it does not acquire Insights from the Insights Server but instead detects thoughts from user activity on the computer (with Seeker and Insight Preview activity disregarded) and presents these thoughts in the Insight Previewer.

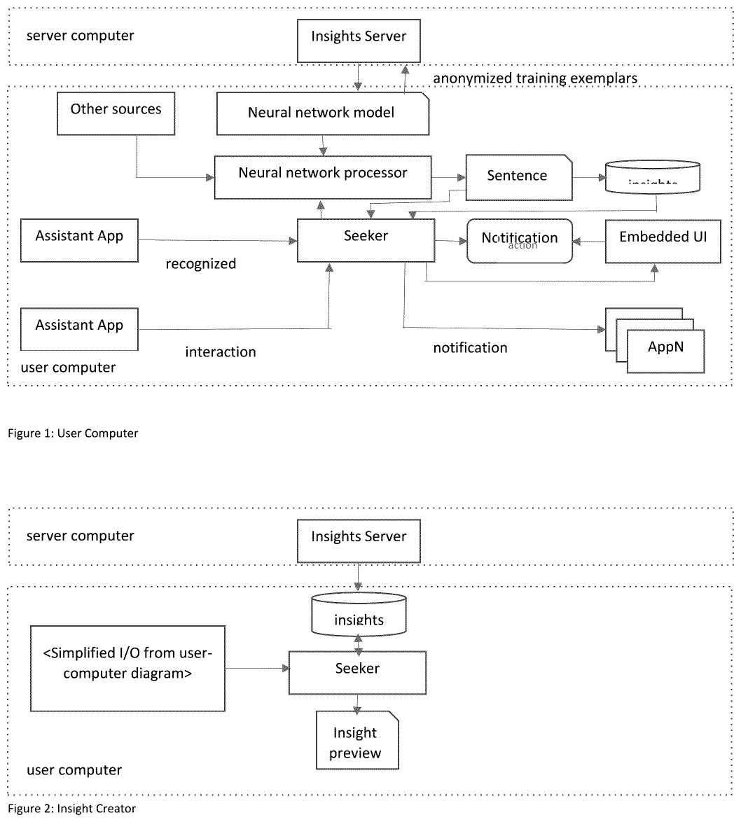

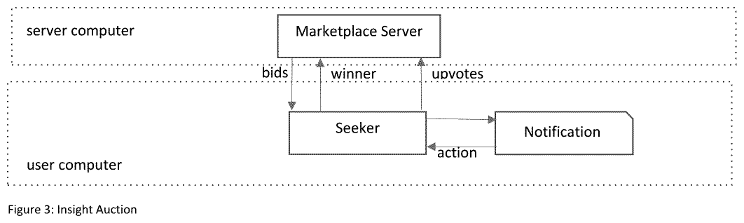

The Insight Previewer is an interface where Notification text and Actions can be associated with one or more thoughts. These together form an Insight. If approved for inclusion in the Insights Server, these are available to all users.

When one or more Insights is matched to a thought, all insights will compete with one another through an electronic bidding process (see FIG. 3) to select the highest bidder which will then display the associated User interface.

A user can vote up (or down) any Notification received based on whether it was a useful insight/suggestion.

### DETAILED DESCRIPTION OF THE INVENTION

There are four kinds of users of the system: the consumer, the Insight Creator, the Auctioneer, and the Rater.

Each user uses the system in the following ways: 1) a Consumer user receives Insights and takes actions on them; 2) an Insight Creator is a developer that uses the Insight Creator to detect thoughts from operations the user performs on the computer; 3) the Auctioneer uses an insight already created, establishes bidding rules the system will follow during the Insight Auction to automatically detect a winner and specifies the content to be displayed if their rules win the auction; 4) a Rater views insight ratings by Consumers and identifies example user ratings of the insight to either reinforce or deemphasize the weightings of the Neural network for the inputs used to produce a thought.

Insight Server: handles Remote Procedure Calls from the Seeker. It contains Insights keyed by thought which are provided to the Seeker. The Seeker also provides the Neural Network model. The model configures the Neural Network processor. Seeker provides inputs to the neural network from recognized text, IPCs between Apps, and Other Sources that have been integrated through APIs.

Marketplace Server: receives up and down votes for an insight. The up and down votes affect which insight wins bids through a point system that rewards better quality insights with higher likelihood of bid winning.

AssistantApp: is not part of the invention. It is an application that receives user audio and initiates queries to a personal assistant. This is an input of text into the Seeker through APIs to the assistant app from the Seeker.

Insight Preview: The Seeker can also operate in an “Insight Creator” mode that presents a summary of the thought detected by the Neural Network processing and allows the user to name this thought as an Insight which is placed into a database.

The Insights Database stores Auction rules (“AuctionRule”) with a starting monetary amount and a maximum bid amount and increments. These are used by the Seeker when an insight is detected on an end user computer to decide which AuctionRule wins the auction. The AuctionRule that wins is allowed to present a Notification or display content in the Embedded UI.

Seeker matches thoughts to available insights, identifies all matches, and conducts an auction among all insights. The winner is chosen by the user's computer by downloading all AuctionRules and choosing the winner from rules and uploading the winning AuctionRule to the MarketPlace Server. The Notification from the winning Insight is displayed to the user. An Embedded Ul enables display. The Embedded Ul initiates an IPC to Seeker to retrieve content.

The Seeker action or application action may call for an Application to initiate further interaction or suggestions. If the Application is not already present it may be suggested to be installed by the Seeker, which will then check back periodically until the Application is installed and then initiate an action in the Application.

When the seeker is in Insight Creator mode the user can try previously created Insights. From an insight a user can establish an AuctionRule such as minimum, incremental, and maximum price. Price and “points” are interchangeable.

The user can provide a rating for the effectiveness of an insight. The bidding process increases the ranking of bids based on how an Auctioneer's Insights and Suggestions are rated. An upvote is used to adjust weights of the Thought Detector (Neural Network Processor) algorithm to either reinforce or deemphasize the thought output for the given inputs. The Seeker will only provide anonymized inputs on request for inputs that are substantially relevant (i.e. exemplars) to training a machine learning algorithm. Thus, user choices may be used for training, but do not contain a reference to the user's identity.

1. The invention is a computer system for providing advice based upon private information about user actions without the necessity for transmitting private information more broadly than it is already transmitted.
a. The system of claim 1 inspects data manipulated by the user's computer.
b. The system of claim 1 keeps information such as that on connected devices or on network devices available to a private algorithm without distribution of this information outside this private environment.
c. The system of claim 1 provides privacy through avoidance of transmission of private data.
d. The system of claim 1 is limited to avoidance of transmission and does not include any new inventions involving encryption or other such means of securing private data.
e. The system of claim 1 includes advice or insight consisting of words defined by a separate system along with a thought that is matched to the neural network's interpretation of user actions.

2. The invention includes a network of computers that transmits rules to a neural network whose structure and algorithm is managed by a central system.
a. The system of claim 2 performs evaluation of the actions in a “playground” or mock environment to allow modeling of user behavior and evaluation of the user's actions to produce a simplified thought from which an insight can be formed and previewed.
b. The system of claim 2 uses a neural network which is running on the user's computer where user actions take place.
c. The system of claim 2's use of a neural network is for the purpose of evaluation of private information.

3. The invention includes a Marketplace to store and distribute to the users computer a plurality of insights associated with rules that detect user actions.
a. The system of claim 3 uses a voting process to rank insights to determine which insights will be presented to the user based on being voted higher.
b. The system of claim 3 uses a bidding process to select insights for presentation to users.
c. The system of claim 3 informs users of potential advice (i.e. insights).
d. The system of claim 3 provides a means for the user to vote on the advice in place.
e. The system of claim 3 informs through mail, notification, or user interfaces embedded programmatically in applications.
